(19) United States
(12) Patent Application Publication
(10) Pub. No.: US 2018/0307700 A1
(43) Pub. Date: Oct. 25, 2018

(54) METHOD AND APPARATUS FOR SCANNING FILES AND INTELLIGENT TERMINAL

(71) Applicant: BEIJING KINGSOFT INTERNET SECURITY SOFTWARE CO., LTD., BEIJING (CN)

(72) Inventor: Xionghui Guo, BEIJING (CN)

(21) Appl. No.: 15/839,118

(22) Filed: Dec. 12, 2017

(30) Foreign Application Priority Data
Apr. 25, 2017 (CN) 201710278614.X

(51) Int. Cl. G06F 17/30; G06F 21/56

(52) U.S. Cl. CPC G06F 17/30147; G06F 21/562; G06F 17/3048; G06F 17/30303; G06F 17/30106

(57) ABSTRACT

Embodiments of the present disclosure provide a method and an apparatus for scanning files and an intelligent terminal. The method includes: performing a first scan processing on a target directory according to a first processing strategy to obtain a target file meeting a processing condition preset in the first processing strategy; and determining a file identification of the target file, searching for a file data size value corresponding to the file identification in preset record information, and returning the file data size value, in which the preset record information comprises at least file identifications of files contained in the target directory and file data size values corresponding to the files contained in the target directory.

### CROSS-REFERENCE TO RELATED APPLICATION

This application is based on and claims priority and benefits of Chinese Patent Application Serial No. 201710278614.X, filed with the State Intellectual Property Office of P R. China on Apr. 25, 2017, the entire content of which is incorporated herein by reference.

### FIELD

The present disclosure relates to a computer application technology field, and more particularly, to a method and an apparatus for scanning files and an intelligent terminal.

### BACKGROUND

With continuous development of electronic technologies and computer application technologies, a user can make use of intelligent terminals such as high-performance mobile phones and various applications (APP for short) to achieve all kinds of functions, so as to meet his/her needs on work, living and learning. For example, it may be very convenient for the user to chat with other users by speeches, videos and texts based on a smart phone and an instant messaging APP.

However, the more APPs are installed by the user, the more junk files may be generated. Sometimes, virus files may be received during message receiving. Thus, it is necessary to scan files in the intelligent terminal to remove the junk files and the virus files and the like.

In existing solutions for scanning files of a terminal, each time a target file is scanned, in order to obtain a data size of the target file, a corresponding interface of a file system of the terminal should be called to calculate the data size of the target file, which is time-consumed and may affect the efficiency of file scanning.

### SUMMARY

Embodiments of the present disclosure provide a method and an apparatus for scanning files and an intelligent terminal, which may scan files in a directory of the intelligent terminal quickly.

To achieve the above objectives, embodiments according to a first aspect of the present disclosure provide a method for scanning files. The method includes: performing a first scan processing on a target directory according to a first processing strategy to obtain a target file meeting a processing condition preset in the first processing strategy, in which the first processing strategy is determined based on a type of scanning objects of the first scan processing; and determining a file identification of the target file, searching for a file data size value corresponding to the file identification in preset record information, and returning the file data size value; in which, the preset record information includes at least file identifications of files contained in the target directory and file data size values corresponding to the files contained in the target directory.

To achieve the above objectives, embodiments according to a second aspect of the present disclosure provide an apparatus for scanning files, the apparatus includes: a scanning module, configured to perform a first scan processing on a target directory according to a first processing strategy to obtain a target file meeting a processing condition preset in the first processing strategy, in which the first processing strategy is determined based on a type of scanning objects of the first scan processing; and a processing module, configured to determine a file identification of the target file, search for a file data size value corresponding to the file identification in preset record information and return the file data size value.

To achieve the above objectives, embodiments according to a third aspect of the present disclosure provide an intelligent terminal including a processor and a memory, in which the memory is configured to store target files; the processor is configured to: perform a first scan processing on a target directory according to a first processing strategy to obtain a target file meeting a processing condition preset in the first processing strategy, in which the first processing strategy is determined based on a type of scanning objects of the first scan processing; and determine a file identification of the target file, search for a file data size value corresponding to the file identification in preset record information, and return the file data size value; in which, the preset record information includes at least file identifications of files contained in the target directory and file data size values corresponding to the files contained in the target directory.

To achieve the above objectives, embodiments according to a fourth aspect of the present disclosure provide a non-transitory computer-readable storage medium, stored thereon with computer programs that, when executed by a processor, perform the method for scanning files according to the first aspect of the present disclosure.

To achieve the above objectives, embodiments according to a fifth aspect of the present disclosure provide a computer program product. When instructions stored in the computer program product are executed by a processor, the method for scanning files according to the first aspect of the present disclosure is performed.

With embodiments of the present disclosure, in a file scanning scenario, the size of the target file may be quickly obtained during the file scanning based on preset record information including at least the data size values of the files, thus improving the efficiency of the file scanning, reducing software and hardware resources required for the file scanning and saving power consumption of the terminal while scanning the files.

### BRIEF DESCRIPTION OF THE DRAWINGS

FIG. 1 is a schematic diagram illustrating a structure of a caching tree according to embodiments of the present disclosure.

FIG. 2 is a flow chart illustrating a method for scanning files according to an embodiment of the present disclosure.

FIG. 3 is a flow chart illustrating a method for scanning files according to another embodiment of the present disclosure.

FIG. 4 is a flow chart illustrating a method for scanning files according to yet another embodiment of the present disclosure.

FIG. 5 is a flow chart illustrating a method for scanning files according to still another embodiment of the present disclosure.

FIG. 6 is a block diagram of an apparatus for scanning files according to embodiments of the present disclosure.

FIG. 7 is a schematic diagram illustrating an intelligent terminal according to embodiments of the present disclosure.

### DETAILED DESCRIPTION

Embodiments of the present disclosure will now be descried in detail with reference to accompany drawings as follows.

For an intelligent terminal, file scanning inside the terminal is generally performed for the purpose of finding designated files, such as junk files and virus files. Moreover, different processing strategies may be utilized for different processing purposes, and a plurality of file scanning may be performed in one scan to better obtain target files which meet processing conditions in corresponding processing strategies. In detail, when scanning the junk files in the intelligent terminal (for example a smart phone with an operating system), since the junk files usually include cache junk files, residual junk files and unwanted installation package files, it may need to perform three times of scanning based on different processing strategies during a file scan processing of the intelligent terminal to obtain target files meeting corresponding processing conditions respectively in the terminal, such as the cache junk files, the residual junk files and the unwanted installation package files.

In embodiments of the present disclosure, a scan button may be provided in a file scanning application. Once the file scanning application is launched the scan button is clicked by the user, the scan processing based on different processing strategies may be triggered to start. Of course, the scan processing not only can be triggered by operations on the scan button, but also may be triggered by other trigger conditions. For example, the trigger condition may be reaching a predetermined scanning trigger time or detecting that a data size of files in a designated directory of the terminal reaches a preset data size threshold, for instance, the data size of files in a recycle bin of the terminal exceeds 100M.

When detecting that the file scanning processing is triggered, a processor runs corresponding program instructions and performs a first scanning according to one type of processing strategy. After scanning a certain target directory is completed, related information of all files and directories contained in the target directory is recorded as record information such as a caching tree. The record information is then stored under a designated directory in a storage area accordingly. In detail, the record information such as one caching tree may be generated separately for the target directory, or the record information may be a part of a greater size of record information, for example, a part of a larger caching tree. After the first scanning is finished, a second scanning is performed according to another type of processing strategy. When the target directory is scanned, the record information corresponding to the target directory is determined and related information of a certain target file in the target directory, such as a data size of the target file and other related information, may be determined based on the record information. In detail, the first scanning above corresponds to performing a first scan processing according to a first processing strategy, the second scanning above corresponds to performing a second scan processing according to a second processing strategy.

When the related information of the directories and files contained in the target directory is stored in a form of a caching tree, each directory or file is corresponding to one node of the caching tree, and information of each node contains the related information of the directory or the file corresponding to the node. In embodiments of the present disclosure, the related information of the corresponding directory or file includes at least one of identification information for recording an identification of the directory or file, size information for recording data size of the file, parent-directory information for recording a parent directory of the directory or file, and identification indication information for recording intermediate directories or files contained in the directory.

In detail, in an embodiment of the present disclosure, taking the first scanning for scanning a target directory “storage” in the storage area of the terminal as an example, the directories and files in the target directory “storage” are as follows:

/storage/emulated/0/a/d;

/storage/emulated/0/b/e/f;

/storage/emulated/0/b/e/g;

/storage/emulated/0/b/e/h;

/storage/emulated/0/b/c.

That is to say, directories “emulated”, “0”, “a”. “b”, “e” are stored in the target directory “storage” and specific files include files “d”, “f”, “g”, “h” and “c”. Based on all the directories and files in the target directory “storage”, a caching tree as illustrated in FIG. 1 is generated for the target directory “storage”. Each intermediate node in the caching tree is a directory node, and each leaf node of the caching tree is a file node. In embodiments of the present disclosure, the caching tree may be implemented by a linear array and each element in the array represents one node. With respect to the caching tree illustrated in FIG. 1, a corresponding array is stored as illustrated in Table 1.

TABLE 1

| Index | 1 | 2 | 3 | 4 | 5 | 6 | 7 | 8 | 9 | 10 | 11 |
|---|---|---|---|---|---|---|---|---|---|---|---|
| node | storage | emulated | 0 | a | b | c | d | e | f | g | h |

In the array, related information of the directories or files is recorded in corresponding nodes. Data structures of respective nodes may be same or different. In detail, in embodiments of the present closure, information contained in each node is as illustrated in Table 2.

TABLE 2

| | | |
|---|---|---|
| intex | index | index of the node |
| name | name | name of the file (directory) |
| type | file type | indicating whether the node is corresponding to |
| | | a directory or a file |
| size | file size | for a file, storing the size of the file (−1 for |
| | | files without a calculated file size) |
| parentIndex | index of a | index of a parent directory of the file/directory |
| | parent | (−1 for the first node) |
| | node | |
| subFirst | index of a | index of a first sub-file (−1 for a file node or a |
| | first | node whose sub-files are not listed) |
| | sub-file | |
| subLast | index of a | index of a last sub-file (−1 for a file node or a |
| | last | node whose sub-files are not listed) |
| | sub-file | |

In addition, all the nodes between subFirst and subLast, including file nodes and directory nodes, are child nodes of the directory. For example, node information with respect to node “e” in FIG. 1 is illustrated as in Table 3.

TABLE 3

| | |
|---|---|
| index | 8 |
| name | e |
| type | directory |
| size | −1 |
| parentIndex | b |
| subFirst | 9 |
| subLast | 11 |

In detail, “name” may be considered as a file identification or a directory identification; “size” records a file data size value of the file; “parentIndex” records parent directory information; “subFirst” and “subLast” record identification indication information of intermediate directories or files contained in the directory. For example, item “e” corresponds to a directory and has an identification of e, and thus the value of “size” is −1. For item “e”, an index of the first file is 9 (i.e. file f) and an index of the last file is 11 (i.e. file h).

During the first scanning, corresponding data is required for establishing the above caching tree. For example, it requires to obtain whether a certain directory contained in the target directory has an intermediate directory and to obtain a size of a certain file contained in the target directory. These kinds of information may be obtained by calling a file interface of the system in the first scanning. For example, when directory “e” is being scanned, the file interface of the system is called to detect that files f, g and h are contained in the directory e, and a file list is then returned by the file interface to facilitate establishing parts related to the directory e of the caching tree. When file f under directory e is being scanned, the file interface is also called to detect data size of file f, and a value of the data size of file f is returned by the file interface.

Once the above caching tree including related data is established, when the target directory is scanned next time, the related information may be obtained based on the caching tree without calling the file interface of the system. The related information may include the data size value of a certain file, a list of intermediate directories and files under a certain directory, and the like.

In an embodiment, for the scan processing for junk files, in the first scanning, the target directory is scanned according to a processing strategy for cache junk files and a corresponding caching tree is established. Then, in the second scanning for scanning the target directory according to a processing strategy for residual junk files, if a certain target file is scanned as a residual junk file, a corresponding file node is found from the caching tree based on a file identification of the residual junk file, and a data size value in the file node is returned as a part of the scan result. Thus, there is no need to calculate the size of the target file. For instance, during scanning the target directory “storage”, if file “c” is a residual junk file, a value of “size” in node “c” can be directly obtained from the caching tree and returned without the need of calculating the size of the file “/storage/emulated/0/b/c”. When contents of a directory “/storage/emulated/0/b/e/” need to be enumerated during the scanning, a sub-file list (node 9-node 11) of node “e” may be directly returned based on the caching tree.

The method for scanning files according to embodiments of the present disclosure will be described in detail as follows. In following embodiments, the method for scanning files may be applied to an intelligent terminal such as a smart phone, a tablet computer, and a smart wearable device, and may be implemented by a processor of the intelligent terminal.

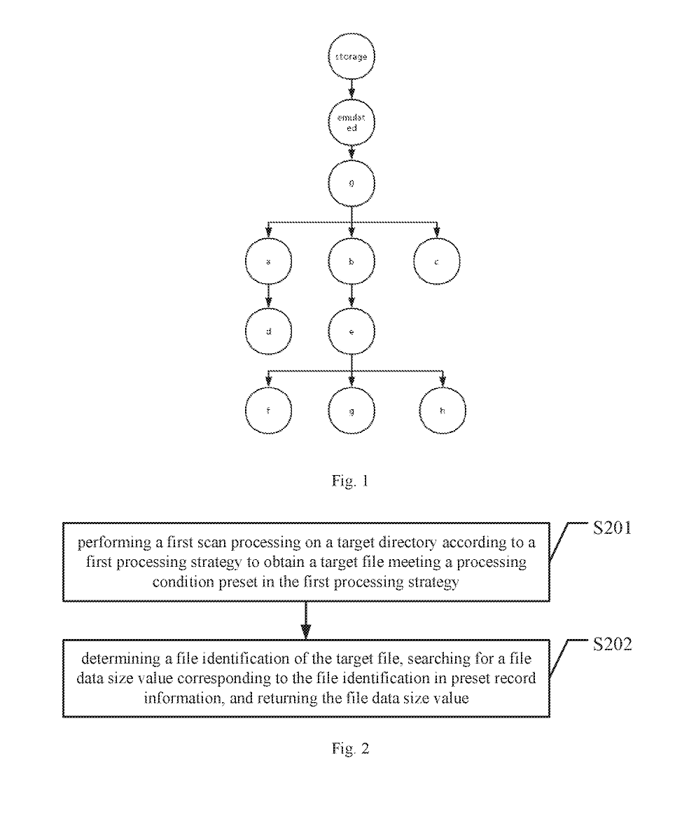

Referring to FIG. 2, FIG. 2 is a flow chart illustrating a method for scanning files according to an embodiment of the present disclosure. In the present embodiment of the present disclosure, record information may be preset based on the above caching tree. The method may include following acts.

At block S201, a first scan processing is performed on a target directory according to a first processing strategy, and a target file meeting a processing condition preset in the first processing strategy is obtained, in which the first processing strategy is determined based on a type of scanning objects of the first scan processing. The first processing strategy is generally determined based on a goal of this scanning and the type of scanning objects of this scanning. For example, when the goal is scanning out junk files in the terminal and the objects of the scanning are residual junk files, the processing strategy may be configured based on characteristics of residual junk files. For instance, the processing strategy may be configured based on a filename extension characteristic of files, so that residual junk files with a corresponding filename extension may be scanned out.

Since the files stored in the terminal are stored and managed by a file system of an operating system, during scanning, a corresponding interface of the file system may be called to scan all the files in the target directory to obtain a target file which has a corresponding characteristic and meets the processing condition preset in the first processing strategy. Then the target file may be analyzed and processed at block S202.

In an embodiment of the present disclosure, the target file may be a file which is stored in the target directory and meets the corresponding processing condition, for example, a certain file which meets the characteristic of the residual junk files in above mentioned files c, d, f, g, h.

At block S202, a file identification of the target file is determined, a file data size value corresponding to the file identification is searched for in the preset record information and the found file data size value is returned. In an embodiment, the preset record information records at least file identifications of files contained in the target directory and file data size values corresponding to the files contained in the target directory. As the example of the caching tree described above, the data size value recorded in “size” of the file node can be returned based on the file identification “name” of the target file without calculating the size of the target file for another time.

With embodiments of the present disclosure, in a file scanning scenario, the size of the target file may be quickly obtained during the file scanning based on preset record information including at least the data sizes of the files, thus improving the efficiency of the file scanning, reducing software and hardware resources required for the file scanning and saving power consumption of the terminal while scanning the files.

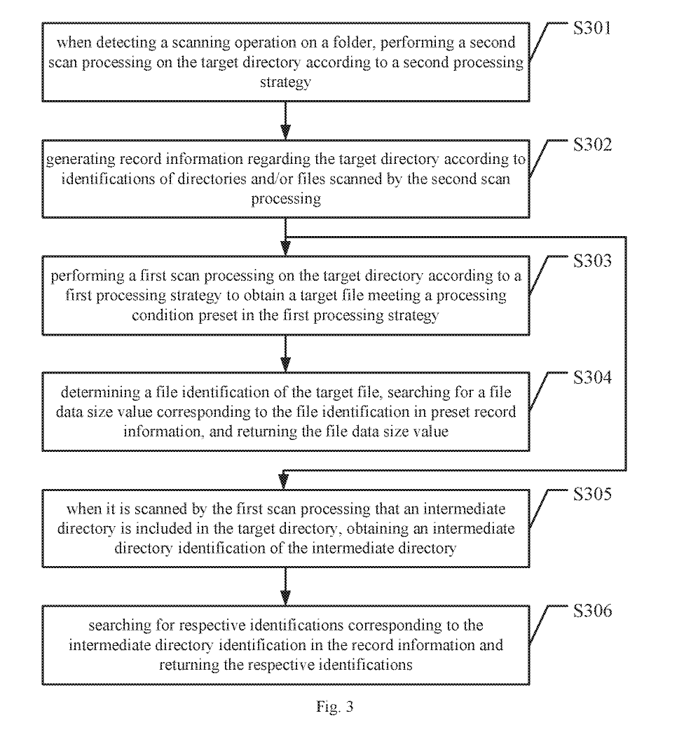

Referring to FIG. 3, FIG. 3 is a flow chart illustrating a method for scanning files according to another embodiment of the present disclosure. In embodiments of the present disclosure, terms such as “first” and “second” are just used for distinguishing different processing strategies and scanning processes, but not intend to indicate orders of acts. The method according to embodiments of the present disclosure may include following acts.

At block S301, a second scan processing is performed on a target directory according to a second processing strategy when detecting a scanning operation on a folder. The second processing strategy is determined based on a type of scanning objects of the second scan processing.

At block S302, record information regarding the target directory is generated according to identifications of directories and/or files scanned by the second scanning. For example, the above caching tree is generated.

After the second scan processing is performed according to the second processing strategy, a first scan processing may be performed on the target directory according to a first processing strategy. In embodiments of the present disclosure, the first scan processing may be performed based on a true scan result. If there is a target file under the target directory, the following acts S303 and S304 are performed; if there is an intermediate directory such as a sub-directory under the target directory, then following acts S303 and S304 are performed.

At block S303, the first scan processing is performed on the target directory according to the first processing strategy, and a target file meeting a processing condition preset in the first processing strategy is obtained, in which the first processing strategy is determined based on a type of scanning objects of the first scan processing. The target file may be a certain file under the target directory or a certain file under an intermediate directory of the target directory. Whenever a file meeting the processing condition preset in the first processing strategy is scanned, the file is considered as the target file and following act S304 is performed.

At block S304, a file identification of the target file is determined, a file data size value corresponding to the file identification is searched for in the preset record information and the found file data size value is returned, in which, the preset record information includes at least file identifications of files contained in the target directory and file data size values corresponding to the files contained in the target directory.

At block S305, when it is scanned in the first scan processing that an intermediate directory is included in the target directory, an intermediate directory identification of the intermediate directory is obtained. The intermediate directory may include one or more directories under the target directory, as illustrated in FIG. 1, for example, if the target directory is “storage”, then the sub-directory “emulated” under “storage” is an intermediate directory. During the scanning, a sub-directory “0” of the directory “emulated” and a sub-directory “a” and a sub-directory “b” of the sub-directory “0” are also considered as intermediate directories.

At block S306, respective identifications corresponding to the intermediate directory identification are searched for in the record information and the found respective identifications are returned. Once the intermediate directory is determined, the intermediate directory identification of the intermediate directory is further determined, and further identifications of all directories and files under the intermediate directory are found according to above caching tree, and a list including these identifications is returned. For example, as illustrated in FIG. 1, with respect to the intermediate directory “0”, identifications of the directory “a”, the directory “b” and the file “c” are returned.

Further processing may be performed on the returned identifications, for example, a directory corresponding to a directory identification in the returned identifications may be scanned as a target directory, or it is directly determined whether a file corresponding to a file identification in the returned identifications is a target file. Based on the caching tree, further scanning on sub-directories or files contained in a certain intermediate directory may be performed directly according to obtained identifications, and there is no need to call a system interface to obtain the identifications of those sub-directories or files contained in the intermediate directory.

With embodiments of the present disclosure, in a file scanning scenario, the size of the target file and all identifications under a certain directory may be quickly obtained during the file scanning based on preset record information including at least the data size values of the files, which is convenient for performing further scan processing, thus improving the efficiency of file scanning, reducing software and hardware resources required for the file scanning and saving power consumption of the terminal while scanning the files.

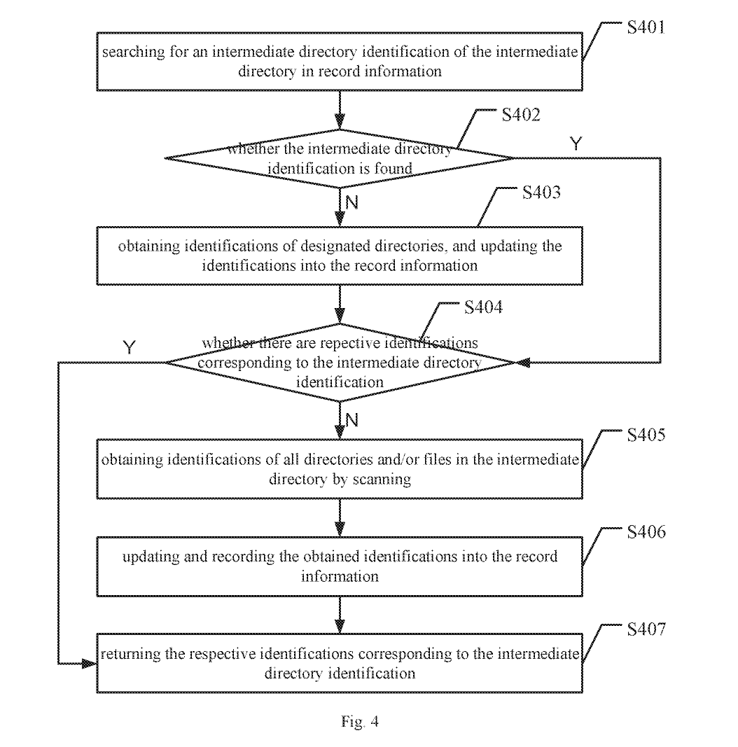

Alternatively, in embodiments of the present disclosure, the method may include processing in a case when there is no directory identification of the intermediate directory in the record information such as the caching tree, or in a case when one or more identifications under the directory identification of the intermediate directory are not found. FIG. 4 is a flow chart illustrating a method for scanning files according to yet another embodiment of the present disclosure. As illustrated in FIG. 4, the method includes following acts.

At block S401, an intermediate directory identification of an intermediate directory is searched for in record information.

At block S402, whether the intermediate directory identification is found is determined. If it is determined that the intermediate directory identification is not included in the record information, following act S403 is performed. Otherwise, following act S404 is performed.

At block S403, identifications of designated directories are obtained and updated into the record information. In detail, identifications of designated directories from a root directory of a folder where the target directory is to the intermediate directory are obtained and recorded in the record information, in which respective identifications of designated directories are associated with the intermediate directory identification. In more detail, the identifications of designated directories may include identifications of all directories in a file path from the root directory of the folder where the target directory is to the intermediate directory, or may include identifications of a part of directories in the file path from the root directory of the folder where the target directory is to the intermediate directory, the part of directories being previously not recorded in the record information. As above mentioned, when the root directory is “storage”, and the intermediate directory is directory “b”, the designated directories may include directory “storage”, directory “emulated” and directory “0”.

At block S404, it is determined whether there are respective identifications corresponding to the intermediate directory identification included in the record information. In an embodiment, it is determined whether there are identifications corresponding to directories or files under the intermediate directory. Generally, a directory includes at least one or more files. Therefore, when one or more identification corresponding to the intermediate directory identification are not found in the record information, following act S405 is performed. When one or more identifications corresponding to the intermediate directory identification are found in the record information, following act S407 is performed.

At block 405, identifications of all directories and/or files in the intermediate directory are obtained by scanning. In detail, a system interface may be called to scan directories or files contained in the intermediate directory and determine the identifications.

At block S406, the obtained identifications are updated and recorded in the record information, in which the obtained identifications are associated with the intermediate directory identification.

At block S407, the respective identifications corresponding to the intermediate directory identification are returned. That is to say, when a list of identifications of directories and/or files corresponding to the intermediate directory identification is found directly in the record information, the identifications of directories and/or files under the intermediate directory are returned as a scan result, so that a following directory scanning or file scanning may be performed based on these identifications without calling the system interface to scan the intermediate directory. When the list of identifications of directories and/or files corresponding to the intermediate directory identification is not found, the intermediate directory is scanned by calling the system interface and the corresponding identifications are returned and the record information such as the caching tree is updated as well, so that all the identifications under the intermediate directory may be found directly during the next scanning without the need of calling the system interface again.

With embodiments of the present disclosure, in a file scanning scenario, the size of the target file may be quickly obtained during the file scanning based on preset record information including at least the data size values of the files, thus improving the efficiency of the file scanning, reducing software and hardware resources required for the file scanning, and saving power consumption of the terminal while scanning the files. Moreover, the record information may be updated thoroughly and effectively, thus making it convenient for following file scanning.

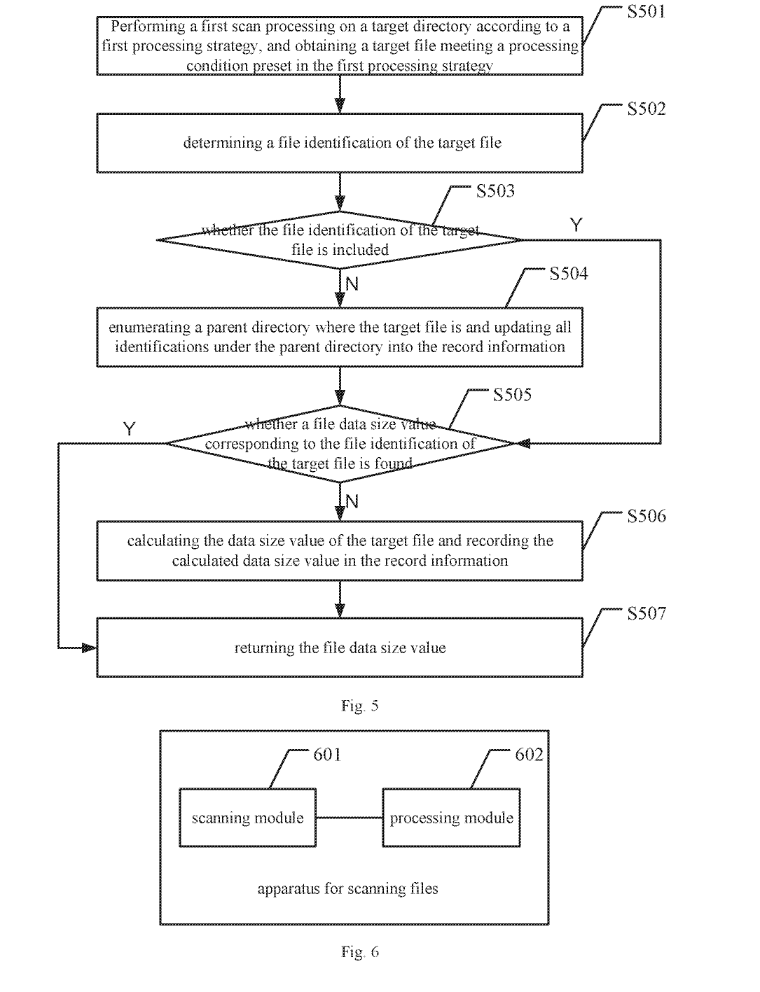

Referring to FIG. 5, FIG. 5 is a flow chart illustrating a method for scanning files according to still another embodiment of the present disclosure. Comparing to above embodiments described with reference to FIG. 2, the method according to embodiments of the present disclosure may further include processing in a case when there is no file identification of the target file in the record information, or in a case when there is no file data size value corresponding to the file identification of the target file in the record information. In detail, the method may include following acts.

At block S501, a first scan processing is performed on a target directory according to a first processing strategy, and a target file meeting a processing condition preset in the first processing strategy is obtained, in which the first processing strategy is determined based on a type of scanning objects of the first scan processing.

At block S502, a file identification of the target file is determined.

At block S503, it is determined whether the file identification of the target file is included in the record information. If the file identification is not included, then following act S504 is performed, and if the file identification is included, then following act S505 is performed.

At block S504, a parent directory where the target file is is enumerated and all identifications under the parent directory are updated to the record information. All files and/or directories included in the parent directory where the target file is may be scanned to obtain corresponding identifications of the files and/or directories. All the obtained identifications are recorded in the record information and associated with an identification of the parent directory. In detail, a system interface may be called for scanning all the files and/or directories included in the parent directory to obtain identifications thereof, and respective nodes under a directory node corresponding to the parent directory in the caching tree are updated according to all the obtained identifications. The update may include supplementing information of respective nodes under the directory node corresponding to the parent directory in the caching tree, and updating previously recorded information such as “size” in a file node corresponding to the target file by calling a file system interface.

At block S505, it is determined whether a file data size value corresponding to the file identification of the target file is found. If the corresponding file data size value is not found, following act S506 is performed, and if the corresponding file data size value is found, following act S507 is performed.

At block S506, a data size value of the target file is calculated and the calculated data size value is recorded in the record information. The calculated data size value is considered as the file data size value and associated with the file identification of the target file. In detail, the data size value of the target file may be calculated by calling the system interface and updated into item “size” of the node information in the caching tree so as to enable the calculated data size value to be associated with the file identification.

At block S507, the file data size value is returned. The returned file data size value may be the data size value of the target file found in the record information such as the caching tree, or may be the data size value of the target file calculated in act S506 when the file data size value cannot be found in the record information.

With embodiments of the present disclosure, in a file scanning scenario, the size of the target file may be quickly obtained during the file scanning based on preset record information including at least the data size values of the files, thus improving the efficiency of the file scanning, reducing software and hardware resources required for the file scanning, and saving power consumption of the terminal while scanning the files. Moreover, the record information may be updated thoroughly and effectively, thus making it convenient for following file scanning.

Embodiments of the present disclosure further provide a non-transitory computer-readable storage medium, stored thereon with computer programs that, when executed by a processor, perform the method for scanning files as illustrated in above embodiments with reference to FIGS. 2, 3, 4 and 5.

Embodiments of the present disclosure further provide a computer program product. When instructions stored in the computer program product are executed by a processor, the method for scanning files as illustrated in above embodiments with reference to FIGS. 2, 3, 4 and 5 is performed.

An apparatus for scanning files and an intelligent terminal according to embodiments of the present disclosure will be illustrated in detail as follows.

Referring to FIG. 6, FIG. 6 is a block diagram of an apparatus for scanning files according to embodiments of the present disclosure. The apparatus for scanning files according to embodiments of the present disclosure may be applied to intelligent terminals such as smart phones, tablet computers, smart wearable devices, etc. In an embodiment, the apparatus includes a scanning module 601 and a processing module 602.

The scanning module is configured to perform a first scan processing on a target directory according to a first processing strategy to obtain a target file meeting a processing condition preset in the first processing strategy. The processing module 602 is configured to determine a file identification of the target file, search for a file data size value corresponding to the file identification in preset record information and return the file data size value, in which, the preset record information includes at least file identifications of files contained in the target directory and file data size values corresponding to the files contained in the target directory.

Alternatively, the record information further includes intermediate directory identifications of intermediate directories under the target directory, and file identifications of files contained in the intermediate directories and/or sub-directory identifications of sub-directories under the intermediate directories. The processing module 602 is further configured to, when an intermediate directory is obtained after the first scan processing, obtain an intermediate directory identification of the intermediate directory, search for respective identifications corresponding to the intermediate directory identification in the record information and return the found respective identifications.

Alternatively, the scanning module 601 is further configured to perform a second scan processing on the target directory according to a second processing strategy when detecting a scanning operation on a folder, in which the second processing strategy is determined based on a type of scanning objects of the second scan processing; and the apparatus further includes a generating module, configured to generate record information regarding the target directory according to identifications of directories and/or files scanned by the second scan processing.

Alternatively, the scanning module 601 is further configured to scan all files and/or directories included in a parent directory where the target file is to obtain corresponding identifications of files and/or directories, when the file identification of the target file is not found in the record information. The processing module 602 is further configured to record the obtained identifications in the record information and to associate the obtained identifications with an identification of the parent directory.

Alternatively, the processing module 602 is further configured to, when the file data size value corresponding to the file identification of the target file is not found in the preset record information, calculate a data size value of the target file and record the calculated data size value in the record information, in which the calculated data size value is associated with the file identification of the target file as the file data size value.

Alternatively, the processing module 602 is further configured to, when the intermediate directory identification of the intermediate directory is not included in the record information, obtain identifications of designated directories from a root directory of a folder where the target directory is to the intermediate directory and to record the identifications of designated directories into the record information, in which the identifications of designated directories are associated with the intermediate directory identification.

The identifications of designated directories may include identifications of all directories in a file path from the root directory of the folder where the target directory is to the intermediate directory, or may include identifications of a part of directories in the file path from the root directory of the folder where the target directory is to the intermediate directory, the part of directories being previously not recorded in the record information.

Alternatively, the processing module 602 is further configured to, when one or more identifications corresponding to the intermediate directory identification are found in the record information, scan all directories and/or files contained in the intermediate directory to obtain identifications thereof, and update and record the obtained identifications into the record information, in which the obtained identifications are associated with the intermediate directory identification.

Alternatively, the record information is established as a caching tree, the caching tree includes a plurality of nodes and records association relationships among respective nodes, in which each node records related information of one directory or one file. In the caching tree, leaf nodes are configured to record related information of files and other nodes are configured to record related information of directories.

Alternatively, the related information recorded in the node includes: identification information including a name of a directory or a name of a file; data size information including a data size value of the file; parent directory information including information of a parent directory of the directory or information of a parent directory of the file; and identification indication information including indication information of files included in the directory or information of directories included in the directory.

Alternatively, the identification indication information includes an index of a first file or a first directory included in the directory and an index of a last file or a last directory included in the directory.

It should be noted that, with respect to the detailed implementations of respective modules according to device embodiments of the present disclosure, reference may be made to related content described in method embodiments illustrated with reference to FIG. 1 to FIG. 5, which will not be elaborated here.

With embodiments of the present disclosure, in a file scanning scenario, the size of the target file may be quickly obtained during the file scanning based on preset record information including at least the data size values of the files, thus improving the efficiency of the file scanning, reducing software and hardware resources required for the file scanning, and saving power consumption of the terminal while scanning the files. Moreover, the record information may be updated thoroughly and effectively, thus making it convenient for following file scanning.

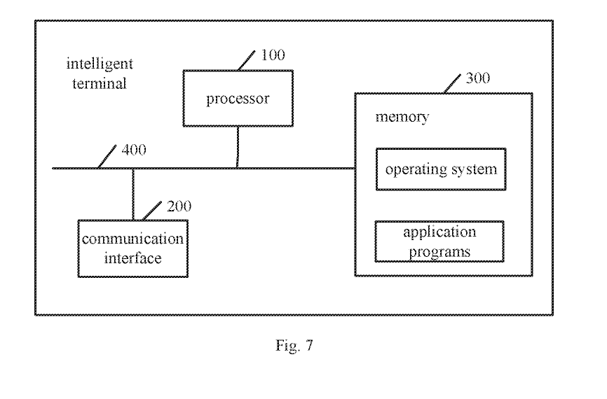

Referring to FIG. 7. FIG. 7 is a schematic diagram illustrating an intelligent terminal according to embodiments of the present disclosure. The intelligent terminal according to embodiments of the present disclosure may include at least one processor 100, at least one communication interface 200, a memory 300 and other components. In an embodiment, the above components are connected and communicate with each other via one or more buses 400. Those skilled in the art should understand that the structure of the intelligent terminal illustrated in FIG. 7 cannot be considered as limits to embodiments of the present disclosure. The structure may be a bus topology or a star topology, may include less or more components than those illustrated in the drawing, or some of the components may be combined, or may be arranged differently.

In detail, the processor 100 is a control center of the intelligent terminal, is connected to various parts of the intelligent terminal via various interfaces and wires, and performs various functions of the intelligent terminal and processes data by running or executing programs and/or modules stored in the memory 300 and invoking data stored in the memory 300. The processor 100 may be implemented by an Integrated Circuit (IC for short), for example, by a single package IC or by connecting a plurality of package ICs with same or different functions. For example, the processor 100 may only include a central processing unit (CPU for short) or include a combination of a CPU, a digital signal processor (DSP for short), a graphic processing unit (GPU for short) and various control chips. In embodiments of the present disclosure, the CPU may be a single-core CPU or a multi-core CPU.

The communication interface 200 may include a standard touch screen, a stand keyboard, a stand camera and the like, or may include a wired interface, a wireless interface, and the like.

The memory 300 may be configured to store software programs and modules and store file data such as corresponding target files. The processor 100 and the communication interface 200 may be configured to perform various functional applications of the intelligent terminal and achieve data processing by calling the software programs and modules stored in the memory 300. The memory 300 generally includes a program storage area and a data storage area, in which the program storage area may be configured to store an operating system, application programs required for at least one function, and the like; and the data storage area may be configured to store data generated while the intelligent terminal is used and the like. In embodiments of the present disclosure, the operating system may be an Android system, an iOS system, a Windows operating system, etc.

In an embodiment, the processor 100 may be configured to perform following acts by invoking the application programs stored in the memory 300: performing a first scan processing on a target directory according to a first processing strategy to obtain a target file meeting a processing condition preset in the first processing strategy; and determining a file identification of the target file, searching for a file data size value corresponding to the file identification in preset record information, and returning the file data size value; in which, the preset record information includes at least file identifications of files contained in the target directory and file data size values corresponding to the files contained in the target directory.

Alternatively, the record information further includes intermediate directory identifications of intermediate directories under the target directory, and file identifications of files contained in the intermediate directories and/or sub-directory identifications of sub-directories under the intermediate directories, and the processor 100 is further configured to perform following acts by invoking the application programs stored in the memory 300: when an intermediate directory is obtained after the first scan processing, obtaining an intermediate directory identification of the intermediate directory; and searching for respective identifications corresponding to the intermediate directory identification in the record information and returning the respective identifications.

Alternatively, before performing a first scan processing on a target directory according to a first processing strategy, the processor 100 is further configured to perform following acts by invoking the application programs stored in the memory 300: when detecting a scanning operation on a folder, performing a second scan processing on the target directory according to a second processing strategy, in which the second processing strategy is determined based on a type of scanning objects of the second scan processing; and generating record information regarding the target directory according to identifications of directories and/or files scanned by the second scan processing.

Alternatively, after determining a file identification of the target file, the processor 100 is further configured to perform following acts by invoking the application programs stored in the memory 300: when the file identification of the target file is not found in the record information, scanning all files and/or directories included in a parent directory where the target file is to obtain corresponding identifications of the files and/or directories; recording obtained identifications in the record information; and associating the obtained identifications with an identification of the parent directory.

Alternatively, the processor 100 is further configured to perform following acts by invoking the application programs stored in the memory 300: when the file data size value corresponding to the file identification is not found in the preset record information, calculating a data size value of the target file; and recording the calculated data size value in the record information, in which the calculated data size value is associated with the file identification of the target file as the file data size value.

Alternatively, the processor 100 is further configured to perform following acts by invoking the application programs stored in the memory 300: when the intermediate directory identification of the intermediate directory is not included in the record information, obtaining identifications of designated directories from a root directory of a folder where the target directory is to the intermediate directory; and recording the identifications of designated directories into the record information, in which the identifications of designated directories are associated with the intermediate directory identification; in which, the identifications of designated directories include identifications of all directories in a file path from the root directory of the folder where the target directory is to the intermediate directory, or include identifications of a part of directories in the file path from the root directory of the folder where the target directory is to the intermediate directory, the part of directories being previously not recorded in the record information.

Alternatively, the processor 100 is further configured to perform following acts by invoking the application programs stored in the memory 300: when one or more identifications corresponding to the intermediate directory identification are not found included in the record information, scanning all directories and/or files contained in the intermediate directory to obtain identifications thereof, updating and recording obtained identifications into the record information, in which the obtained identifications are associated with the intermediate directory identification.

Alternatively, the record information is established as a caching tree, the caching tree includes a plurality of nodes and records association relationships among respective nodes, in which each node records related information of one directory or one file. In the caching tree, leaf nodes are configured to record related information of files and other nodes are configured to record related information of directories.

Alternatively, the related information recorded in the node includes: identification information including a name of the directory or a name of the file; data size information including a data size value of the file; parent directory information including information of a parent directory of the directory or information of a parent directory of the file; and identification indication information including indication information of files included in the directory or indication information of directories included in the directory.

Alternatively, the identification indication information includes an index of a first file or a first directory included in the directory and an index of a last file or a last directory included in the directory.

It should be noted that, with respect to the detailed implementations of the processor 100 according to embodiments of the present disclosure, reference may be made to related content described in method embodiments illustrated with reference to FIG. 1 to FIG. 5, which will not be elaborated here.

With embodiments of the present disclosure, in a file scanning scenario, the size of the target file may be quickly obtained during the file scanning based on preset record information including at least the data size values of the files, thus improving the efficiency of the file scanning, reducing software and hardware resources required for the file scanning, and saving power consumption of the terminal while scanning the files. Moreover, the record information may be updated thoroughly and effectively, thus making it convenient for following file scanning.

In above embodiments, particular emphasis may be put on different parts in different embodiments, and details of parts that are not described in some embodiments may be found in other embodiments.

Reference throughout this specification to “an embodiment”, “some embodiments”, “detailed embodiments”. “an example”, “a specific example”, or “some examples” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples. In addition, those skilled in the art could combine or associate different embodiments, examples or characters of different embodiments or examples, as long as there are no contradictories.

In addition, terms such as “first” and “second” are used herein only for purposes of description and are not intended to indicate or imply relative importance or significance or to imply the number of indicated technical features. Thus, the feature defined with “first” and “second” may comprise one or more of this feature either in a way of imply or indicate. In the description of the present disclosure, “a plurality of” means two or more than two, for example, two, three, etc., unless specifically and particularly prescribed otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, wherein the order of execution may differ from that which is depicted or discussed, including according to involved function, executing concurrently or with partial concurrence or in the contrary order to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer-readable medium comprise but are not limited to: an electronic connection (an electronic device) with one or more wires, a portable computer enclosure (a magnetic device), a random access memory (RAM), a read-only memory (ROM), an erasable programmable read-only memory (EPROM or a flash memory), an optical fiber device and a portable compact disk read-only memory (CDROM). In addition, the computer-readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs, the programs may be stored in a computer-readable storage medium, and the programs comprise one or a combination of the steps in the method embodiments of the present disclosure when running on a computer.

In addition, each function cell of the embodiments of the present disclosure may be integrated into a processing module, or these cells may be separate physical existence, or two or more cells are integrated into a processing module. The integrated module as described above may be achieved in a form of hardware, or may be achieved in a form of software functional module. When the integrated module is realized in a form of software function module and is sold or used as a standalone product, the integrated module may be stored in a computer-readable storage medium.

The storage medium mentioned above may be read-only memories, magnetic disks, CD, etc. Although embodiments of the present disclosure have been shown and described above, it should be understood that above embodiments are just explanatory, and cannot be construed to limit the present disclosure, for those skilled in the art, changes, alternatives, and modifications can be made in the embodiments without departing from spirit, principles, and scope of the present disclosure.

What is claimed is:

1. A method for scanning files, comprising:
performing a first scan processing on a target directory according to a first processing strategy to obtain a target file meeting a processing condition preset in the first processing strategy, wherein the first processing strategy is determined based on a type of scanning objects of the first scan processing; and
determining a file identification of the target file, searching for a file data size value corresponding to the file identification in preset record information, and returning the file data size value;
wherein, the preset record information comprises at least file identifications of files contained in the target directory and file data size values corresponding to the files contained in the target directory.

2. The method according to claim 1, wherein,
the record information further comprises intermediate directory identifications of intermediate directories under the target directory, and file identifications of files contained in the intermediate directories and/or sub-directory identifications of sub-directories under the intermediate directories, and the method further comprises:
when an intermediate directory is obtained after the first scan processing, obtaining an intermediate directory identification of the intermediate directory; and
searching for respective identifications corresponding to the intermediate directory identification in the record information and returning the respective identifications.

3. The method according to claim 1, wherein,
before performing a first scan processing on a target directory according to a first processing strategy, further comprising:
when detecting a scanning operation, performing a second scan processing on the target directory according to a second processing strategy, wherein the second processing strategy is determined based on a type of scanning objects of the second scan processing; and
generating record information regarding the target directory according to identifications of directories and/or files scanned by the second scan processing.

4. The method according to claim 1, wherein,
after determining a file identification of the target file, further comprising:
when the file identification of the target file is not found in the record information, scanning files and/or directories contained in a parent directory where the target file is, to obtain corresponding identifications of the files and/or directories:
recording obtained identifications in the record information; and
associating the obtained identifications with an identification of the parent directory.

5. The method according to claim 1, further comprising:
when the file data size value corresponding to the file identification of the target file is not found in the preset record information, calculating a data size value of the target file; and
recording calculated data size value in the record information, in which the calculated data size value is associated with the file identification of the target file as the file data size value.

6. The method according to claim 2, further comprising:
when the intermediate directory identification of the intermediate directory is not contained in the record information, obtaining identifications of designated directories from a root directory of a folder where the target directory is to the intermediate directory; and
recording obtained identifications of designated directories into the record information, in which the identifications of designated directories are associated with the intermediate directory identification;
wherein, the identifications of designated directories comprise identifications of all directories in a file path from the root directory of the folder where the target directory is to the intermediate directory, or comprise identifications of a part of directories in the file path from the root directory of the folder where the target directory is to the intermediate directory, the part of directories being previously not recorded in the record information.

7. The method according to claim 2, further comprising:
when one or more identifications corresponding to the intermediate directory identification are not found in the record information, obtaining identifications of directories and/or files contained in the intermediate directory by scanning,
recording obtained identifications into the record information, wherein the obtained identifications are associated with the intermediate directory identification.

8. The method according to claim 1, wherein,
the record information is established as a caching tree, the caching tree comprises a plurality of nodes and records association relationships among respective nodes, and each node records related information of one directory or one file;
wherein, leaf nodes in the caching tree are configured to record related information of files and other nodes are configured to record related information of directories.

9. The method according to claim 8, wherein, the related information recorded in the node comprises:
identification information, comprising a name of the directory or a name of the file;
data size information, comprising a file data size value of the file;
parent directory information, comprising information of a parent directory of the directory or information of a parent directory of the file; and
identification indication information, comprising indication information of files contained in the directory or indication information of directories contained in the directory.

10. The method according to claim 9, wherein,
the identification indication information comprises an index of a first file or a first directory contained in the directory and an index of a last file or a last directory contained in the directory.

11. An apparatus for scanning files, comprising:
a processor; and
a memory, configured to store instructions executable by the processor,
wherein, the processor is configured to:
perform a first scan processing on a target directory according to a first processing strategy to obtain a target file meeting a processing condition preset in the first processing strategy, wherein the first processing strategy is determined based on a type of scanning objects of the first scan processing; and
determine a file identification of the target file, search for a file data size value corresponding to the file identification from preset record information and return the file data size value, wherein, the preset record information comprises at least file identifications of files contained in the target directory and file data size values corresponding to the files contained in the target directory.

12. The apparatus according to claim 11, wherein,
the record information further comprises intermediate directory identifications of intermediate directories under the target directory, and file identifications of files contained in the intermediate directories and/or sub-directory identifications of sub-directories under the intermediate directories:
the processor is further configured to:
when an intermediate directory is obtained after the first scan processing, obtain an intermediate directory identification of the intermediate directory; and
search for respective identifications corresponding to the intermediate directory identification in the record information and return the respective identifications.

13. The apparatus according to claim 11, wherein, the processor is further configured to:
perform a second scan processing on the target directory according to a second processing strategy when a scanning operation is detected, in which, the second processing strategy is determined based on a type of scanning objects of the second scan processing; and
generate record information regarding the target directory according to identifications of directories and/or files scanned by the second scan processing.

14. The apparatus according to claim 11, wherein, the processor is further configured to:
scan files and/or directories contained in a parent directory where the target file is to obtain corresponding identifications of the files and/or directories, when the file identification of the target file is not found in the record information;
record obtained identifications in the record information and associate the obtained identifications with an identification of the parent directory.

15. The apparatus according to claim 11, wherein, the processor is further configured to:
when the file data size value corresponding to the file identification of the target file is not found in the preset record information, calculate a data size value of the target file and record calculated data size value in the record information, wherein, the calculated data size value is associated with the file identification of the target file as the file data size value.

16. The apparatus according to claim 12, wherein, the processor is further configured to:
when the intermediate directory identification of the intermediate directory is not contained in the record information, obtain identifications of designated directories from a root directory of a folder where the target directory is to the intermediate directory and to record obtained identifications of designated directories into the record information, in which, the identifications of designated directories are associated with the intermediate directory identification;
wherein, the identifications of designated directories comprise identifications of all directories in a file path from the root directory of the folder where the target directory is to the intermediate directory, or comprise identifications of a part of directories in the file path from the root directory of the folder where the target directory is to the intermediate directory, the part of directories being previously not recorded in the record information.

17. The apparatus according to claim 12, wherein, the processor is further configured to:
when one or more identifications corresponding to the intermediate directory identification are not found in the record information, obtain identifications of directories and/or files contained in the intermediate directory by scanning, and record obtained identifications into the record information, wherein the obtained identifications are associated with the intermediate directory identification.

18. The apparatus according to claim 11, wherein,
the record information is established as a caching tree, the caching tree comprises a plurality of nodes and records association relationships among respective nodes, and each node records related information of one directory or one file;
wherein, leaf nodes in the caching tree are configured to record related information of files and other nodes are configured to record related information of directories.

19. A non-transitory computer-readable storage medium, stored thereon with computer programs that, when executed by a processor, perform a method for scanning files, the method comprising:
performing a first scan processing on a target directory according to a first processing strategy to obtain a target file meeting a processing condition preset in the first processing strategy, wherein the first processing strategy is determined based on a type of scanning objects of the first scan processing; and
determining a file identification of the target file, searching for a file data size value corresponding to the file identification in preset record information, and returning the file data size value;
wherein, the preset record information comprises at least file identifications of files contained in the target directory and file data size values corresponding to the files contained in the target directory.
